(19) United States
(12) Patent Application Publication
(10) Pub. No.: US 2024/0356449 A1
(43) Pub. Date: Oct. 24, 2024

(54) DUAL-BRIDGE SWITCHED-MODE CONVERTER CONTROL

(71) Applicants: Commissariat à l'Energie Atomique et aux Energies Alternatives, PARIS (FR); RENAULT SAS, BOULOGNE BILLANCOURT (FR)

(72) Inventors: Sylvain LEIRENS, GRENOBLE (FR); Xavier MAYNARD, GRENOBLE (FR); Serge LOUDOT, VILLIERS LE BACLE (FR)

(21) Appl. No.: 18/633,249

(22) Filed: Apr. 11, 2024

(30) Foreign Application Priority Data
Apr. 11, 2023 (FR) 2303570

(51) Int. Cl. H02M 3/335; H02M 1/00; H02M 1/42; H02M 7/219

(52) U.S. Cl. CPC H02M 3/33573; H02M 1/0058; H02M 1/4233; H02M 7/219; H02M 3/33584

(57) ABSTRACT

The present description concerns a method of controlling a converter comprising two H bridges coupled by a transformer. Repetitions, at a repetition frequency (fsw), of two switching sequences between a plurality of states are respectively applied to the two bridges. The method comprises first and second modes (MODE 1, MODE 2) of application of the two sequences to the two bridges. Each transition between the first mode (MODE 1) at a nominal value (fsw0) of the repetition frequency (fsw) and the second mode (MODE 2) at the nominal value (fsw0) of the repetition frequency (fsw) comprises an adaptation (fsw1, fsw2) of the repetition frequency (fsw) determined by a first duration of switching dead times.

### BACKGROUND

The present disclosure generally concerns electronic devices, in particular switched-mode converters.

Switched-mode converters use one or a plurality of switches alternately set to the on and off states at a switching frequency. Switched-mode converters are used to deliver a voltage and/or a current from a power supply having voltage/current values different from the voltage/current values to be delivered. For example, an AC-DC (Alternating Current-Direct Current) switched-mode converter enables to obtain a DC voltage from an AC voltage source, such as that of a power grid or of an alternator.

### SUMMARY

There exists a need to overcome all or part of the disadvantages of known switched-mode converters, and in particular of dual active bridge converters (DAB converters).

For example, there exists a need for a method of controlling a switched-mode converter, for example with two active bridges, enabling to keep zero voltage switching (ZVS) operations, for example when the converter switches between two control modes.

An embodiment overcomes all or part of the disadvantages of known switched-mode converters, and, in particular, of dual active bridge converters (DAB converters).

For example, an embodiment provides a method of controlling a switched-mode converter, for example a dual active bridge converter, enabling to keep zero-voltage switching (ZVS) operations, for example when the converter switches between two control modes.

An embodiment provides a method of controlling a converter comprising two H bridges coupled by a transformer, wherein:
repetitions, at a repetition frequency, of two switching sequences between a plurality of states are respectively applied to the two bridges;
one of the states of a first one of the two sequences corresponds to a given direction of application of a voltage to the transformer by the bridge having the first one of the two sequences applied thereto;
in a first control mode, switching operations to enter and leave said one of the states of the first of the two sequences occur in different states of the second one of the two sequences;
in a second control mode, switching operations to enter and leave said one of the states of the first one of the two sequences occur in a same state of a second one of the two sequences; and
each transition between the first mode at a nominal repetition frequency value and the second mode at the nominal repetition frequency value comprises an adaptation of the repetition frequency determined by a first duration equal to a switching dead time duration or to the product of the switching dead time duration and of a zero voltage switching margin.

According to an embodiment, each transition comprises, based on a model of the converter:
the calculation of a first power transferable between the two bridges with the first mode and the nominal value of the repetition frequency, the first power being determined by the first duration;
the calculation of a second power transferable between the two bridges with the second mode and the nominal value of the repetition frequency, the second power being determined by the first duration;
the calculation of a third power transferable between the two bridges in the first and second modes at the nominal value of the repetition frequency and without taking the first duration into account;
the calculation of a first value of the repetition frequency in the first mode, the first value of the repetition frequency being determined by the third transferable power and the first duration; and
the calculation of a second value of the repetition frequency in the second mode, the second value of the repetition frequency being determined by the third transferable power and the first duration.

According to an embodiment:
each transition from the first mode to the second mode comprises a jump from the first value to the second value of the repetition frequency; and
each transition from the second mode to the first mode comprises a jump from the second value to the first value of the repetition frequency.

According to an embodiment:
each transition from the first mode with the nominal value of the repetition frequency to the second mode with the nominal value of the repetition frequency successively comprises:
   in the first mode, transiting from the first power to the third power by transiting from the nominal value of the repetition frequency to the first value of the repetition frequency,
   at the third power, switching from the first mode to the second mode by transiting from the first value of the repetition frequency to the second value of the repetition frequency, and
   in the second mode, transiting from the third power to the second power by transiting from the second value of the repetition frequency to the nominal value of the repetition frequency; and
each transition from the second mode with the nominal value of the repetition frequency to the first mode with the nominal value of the repetition frequency successively comprises:
   in the second mode, transiting from the second power to the third power by transiting from the nominal value of the repetition frequency to the second value of the repetition frequency,
   at the third power, switching from the second mode to the first mode by switching from the second value of the repetition frequency to the first value of the repetition frequency, and
   in the first mode, transiting from the third power to the first power by transiting from the first value of the repetition frequency to the nominal value of the repetition frequency.

According to an embodiment:
the two sequences each comprise two respective switching cycles of two branches of the bridge having the sequence applied thereto; and
the switching of the sequences takes place at times resulting from calculations based on an equality between:
   a set point power to be transferred between the bridges by the converter; and
   a transferable power calculated based on the converter model and based on values of the voltages across the bridges.

According to an embodiment, the set point is calculated as a function of a voltage value received by one of the bridges and/or of a voltage value to be delivered by the other of the bridges.

According to an embodiment, the set point is calculated so that the converter has an operation of PFC (Power Factor Correction) type.

According to an embodiment, said calculations are further based on a desired equality between values of a current in the transformer at one of the switching times of one of the two sequences and at one of the switching times of the other one of the two sequences.

According to an embodiment:
the model comprises a first parameter representative of a second duration between switching times of the two sequences in the first mode and of a third duration between switching times of the two sequences in the second mode;
the first transferable power in the first mode is calculated based on the model by using a first value of the first parameter corresponding to an equality of the first and second durations;
the third transferable power in the first and second modes is calculated based on the model by using a zero value of the first parameter; and
the second transferable power in the second mode is calculated based on the model by using the first value of the first parameter corresponding to an equality of the first and third durations.

According to an embodiment:
in the first mode, the model is determined by the following equation:

$$P = \frac{V {1}^{2}}{4 . m . fsw . L} ( ( - 4 - 4 . {m}^{2} ) . {x}^{2} + ( 4 . {m}^{2} - 2 . m + 2 ) . x + m - {m}^{2} ) \qquad [ Math 21 ]$$

where P is the transferable power, V1 is a voltage across one of the two bridges, x is the first parameter, fsw is the repetition frequency, L is a value of a leakage inductance of the converter, and m is a ratio of a ratio of the voltages across the two bridges to a transformation ratio of the transformer; and in the second mode, the model is determined by the following equation:

$$P = \frac{V {1}^{2}}{4. fsw . L} ( 1 - 2 . x ) ( 1 - m . ( 1 - 2 . x ) - 4 . x ) . \qquad [ Math 22 ]$$

An embodiment provides a device configured to implement the above method.

An embodiment provides a converter comprising the above device.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 schematically shows an example of a switched-mode converter of a type to which the described embodiments apply;

FIG. 2 shows, schematically and in the form of blocks, an example of a method of controlling the converter of FIG. 1;

FIG. 3 shows, schematically and in the form of timing diagrams, an example of an H bridge switching sequence used in embodiments of converter control methods;

FIG. 4 shows, schematically and in the form of timing diagrams, an example of another H bridge switching sequence used in embodiments of converter control methods;

FIG. 5 shows, schematically and in the form of timing diagrams, an example of embodiment of a step of control of a switched-mode converter; and

FIG. 6 shows, schematically and in the form of timing diagrams, an example of embodiment of another step of the control of a switched-mode converter;

FIG. 7 shows, schematically and in the form of blocks, an embodiment of still another step of control of the converter of FIG. 1;

FIG. 8 shows, schematically and by means of curves, an embodiment of still another step of control of the converter of FIG. 1; and

FIG. 9 shows, schematically and in the form of blocks, an embodiment of the control step of FIG. 8.

### DETAILED DESCRIPTION OF THE PRESENT EMBODIMENTS

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail. In particular, converter elements such as switches, driver circuits, a converter transformer, a leakage inductance of a transformer, or capacitive elements, are not described in detail, the described embodiments being compatible with such elements of a conventional converter.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

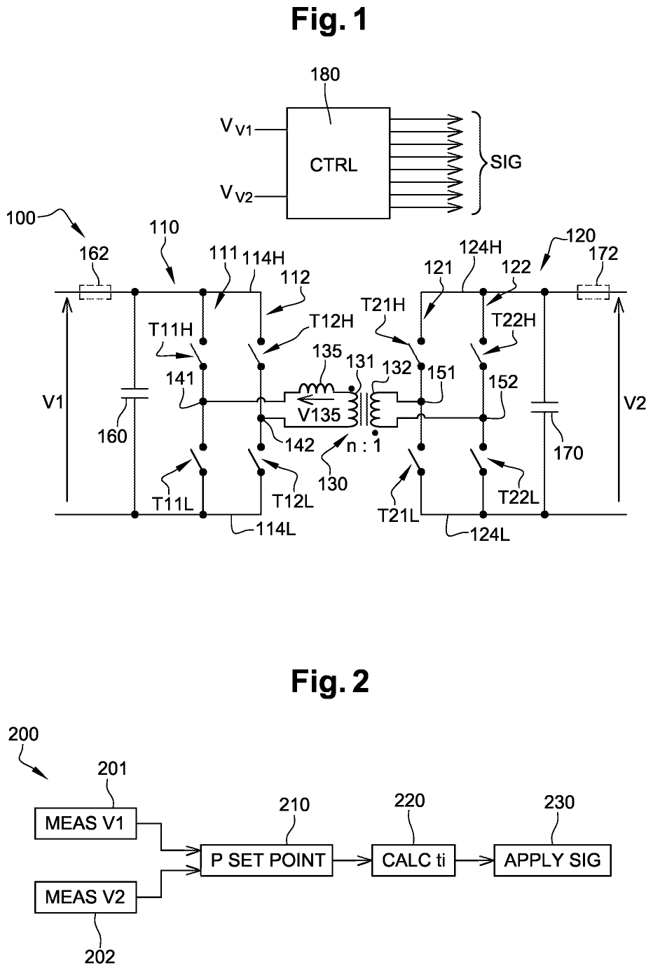

FIG. 1 schematically shows an example of a switched-mode converter 100 of a type to which the described embodiments apply. More particularly, FIG. 1 is a copy of FIG. 1 of patent FR 3 110 300, of patent application EP 3 910 775, and of patent application US 2021359609.

In the shown example, converter 100 receives a voltage V1 and delivers a voltage V2.

Voltage V1 may be an AC voltage, for example delivered by a source such as an electrical power grid. The AC voltage may be of sinusoidal or substantially sinusoidal type. The AC voltage may have an RMS value in the order of 230 V or 110 V, and a frequency equal to 50 Hz or 60 Hz. The AC voltage may also originate from an alternator. As a variant, voltage V1 may be a DC voltage, for example originating from a battery or from photovoltaic cells.

Voltage V2 may be a DC voltage, for example coupled to a battery. As an example, converter 100 may then form a charger of the battery from voltage V1. The battery may be a vehicle battery, and the DC voltage typically varies between 250 V and 450 V during the battery charge, but may reach higher values, for example in the order of 800 V. The converter is then provided to supply the battery with a power level typically in the range from 1 kW to 30 kW during the battery charge. The DC voltage may also, in another example, be supplied to another stage, not shown, of the converter. As a variant, voltage V2 may be an AC voltage, for example coupled to a power grid (the converter then forming an inverter) or to windings of an electric motor.

Converter 100 comprises an H bridge 110, for example receiving voltage V1. By H bridge, there is meant a parallel association of at least two branches (branches 111 and 112 for H bridge 110) between two terminals or nodes (nodes 114H and 114L for H bridge 110).

Each bridge branch is defined by an association of two switches electrically in series between the terminals of the branch. In H bridge 110, branch 111 comprises switches T11H and T11L in series between nodes 114H and 114L, switch T11H being located on the side of node 114H. In H bridge 110, branch 112 comprises switches T12H and T12L in series between nodes 114H and 114L, switch T12H on being located on the side of node 114H.

Converter 100 further comprises an H bridge 120, for example delivering voltage V2. H bridge 120 comprises two branches 121 and 122 electrically in parallel between terminals 124H and 124L. Branch 121 comprises switches T21H and T21L in series between nodes 124H and 124L, switch T21H being located on the side of node 124H. Branch 122 comprises switches T22H and T22L in series between nodes 124H and 124L, switch T22H being located on the side of node 124H.

In examples where voltage V1 is an AC voltage, each of switches T11H, T11L, T12H, T12L is bidirectional for voltage, that is, it is adapted, in its off state, to preventing the flowing of a current in both directions of the voltage across the bidirectional switch. More generally, the switches of the H bridge(s) which, among bridges 110 and 120, deliver and/or receive an AC voltage, are bidirectional for voltage. The described embodiments are compatible with usual types of voltage-bidirectional switches.

Each voltage-bidirectional switch is controlled by the application of a control signal having two levels respectively corresponding to the on and off states of the switch. This application is not described in detail herein, the embodiments being compatible with conventional methods of application to a bidirectional switch of such a control signal.

Preferably, the switches T11H, T11L, T12H, T12L, T21H, T21L, T22H, and T22L of the two bridges are further bidirectional for current, that is, each adapted, in its on state, to allowing the flowing of a current in both directions through the switch. The described embodiments are compatible with usual types of current-bidirectional switches.

H bridges 110 and 120 are coupled by a transformer 130. In other words, the transformer has a winding 131 coupling together two nodes 141 and 142 of one of the H bridges (bridge 110) and another winding 132 coupling together two nodes 151 and 152 of the other of the H bridges (bridge 120). Nodes 141, 142, 151, 152 are nodes of series connection of the switches, respectively T11H and T11L, T12H and T12L, T21H and T21L, T22H and T22L, of the respective branches 111, 112, 121 and 122 of the H bridges. In the shown example, winding 131 has a phase point on the side of node 141 and winding 132 has a phase point on the side of node 152.

Transformer 130 comprises a leakage inductance 135. In the shown example, the leakage inductance couples a terminal of winding 131 to node 141. Leakage inductance 135 may comprise one or a plurality of inductive elements, such as coiled conductors, electrically in series with one and/or other of windings 131 and 132. Leakage inductance 135 may also, totally or partly, result from an incomplete magnetic coupling between windings 131 and 132. In this case, transformer 130 has, between its windings 131 and 132, a coupling coefficient smaller than one.

The transformer has, between windings 132 and 131, a transformation ratio n (n:1). By transformation ratio between a first winding and a second winding, there is meant a ratio of a number of turns of the second winding to a number of turns of the first winding. If transformer 130 is disconnected from the device and if a voltage is applied across winding 132, the transformation ratio is, typically, substantially equal to the ratio of a voltage across winding 131 to the applied voltage. The transformation ratio depends on the voltages involved and on the power to be transferred by the converter. As an example, transformation ratio n is in the range from 0.5 to 2, for example from 0.5 to 1, preferably in the order of 0.75.

In operation, in each branch, the two switches are controlled in reverse, that is, so that, when one of the switches in the branch is in the on or conductive state, the other switch in the branch is in the off or non-conductive state.

Preferably, in each of branches 111, 112, 121, and 122, the switches are alternately set to the on and off states at a switching frequency fsw. In other words, each branch is alternately switched, repeatedly, between a state where one of the switches in the branch is on and another state where the other of the switches is on. Typically, for each switching operation, a dead time is provided, during which the two switches of the switched branch are simultaneously off, to avoid a short-circuiting of the branch terminals. Thus, the two switches of a branch may be simultaneously off, but are controlled not to be simultaneously on.

As an example, when voltage V1, respectively V2, is an AC voltage, the value of this voltage is considered as constant over a switching period equal to 1/fsw when the frequency of voltage V1, respectively V2, is much higher, for example at least 10 times higher, preferably at least 100 times higher, than switching frequency fsw.

In each bridge, the branch switching operations form a switching sequence. The switching sequences of the two branches are repeated at the switching frequency. For each repetition of the switching sequences are repeated, the leakage inductance has the function of storing/releasing energy, so as to have this energy flow from one bridge to the other of the converter.

To achieve this, leakage inductor 135 has, between its terminals, a variable voltage equivalent to a voltage V135 across the shown leakage inductor. More precisely, voltage V135 is located between node 141 and winding 131. The calculation of the value of the voltage V135 across leakage inductance 135 according to the convention chosen to represent this leakage inductance is within the abilities of those skilled in the based on the examples of the present disclosure.

As an example, the converter further comprises a capacitive element 160 coupling the terminals 114L and 114H of H bridge 110. Capacitive element 160 may be formed of a capacitor and/or a plurality of capacitors in series and/or in parallel.

As an example, voltage V1 is applied between nodes 114H and 114L via an impedance 162.

As an example, capacitive element 160 and impedance 162 form a filter enabling to limit variations, at each switching, of the voltage V1 and/or of the current supplied to the converter.

As an example, the converter further comprises a capacitive element 170 coupling the terminals 124L and 124H of H bridge 120. Capacitive element 170 may be formed by a capacitor and/or a plurality of capacitors in series and/or in parallel.

As an example, the voltage V2 between nodes 124H and 124L is delivered by the converter through an impedance 172.

Capacitive element 170 and impedance 172 form, for example, a filter enabling to limit variations, at each switching, of the voltage V2 and/or of the current supplied by the converter.

Converter 100 further comprises a control circuit 180 (CTRL). Control circuit 180 receives values VV1 and VV2 representative of the respective voltages V1 and V2. Values VV1 and VV2 may be generated by any conventional device, not shown, for measuring a voltage between two terminals.

Control circuit 180 delivers signals SIG for controlling switches T11H, T11L, T12H, T12L, T21H, T21L, T22H, and T22L. Control circuit 180 may be formed by any device adapted to implementing a converter control method, and in particular to generating control signals SIG.

For example, control circuit 180 comprises a digital data processing unit, such as a microprocessor, and a memory. The memory for example comprises a program which, when it is read and executed by the processing unit, causes the implementation of the converter control method, that is, the generation of control signals SIG.

Control signals SIG are applied to the switches in a usual way by circuits not shown, such as driver circuits and/or circuits of isolation between reference potentials of the signals for controlling the switches and of control circuit 180.

FIG. 2 shows, schematically and in the form of blocks, an example of a method 200 of controlling the converter of FIG. 1. In particular, FIG. 2 is a copy of FIG. 2 of the above-mentioned French patent and US and EP patent applications.

At a step 201 (MEAS V1), the voltage V1 between terminals 114H and 114L is measured. This results in value V_{V1} (FIG. 1) representative of voltage V1.

As a variant, voltage V1 is predefined. If voltage V1 is an AC voltage, step 201 may then be any step of generation of a value representative of the values of voltage V1 as a function of time, for example any step of generation of values varying sinusoidally in phase with voltage V1. Value VV1 may also be a predefined constant, in the case where voltage V1 is a DC and predefined voltage.

At a step 202 (MEAS V2), the voltage V2 between terminals 124H and 124L is measured. This results in value VV2 (FIG. 1), representative of voltage V2. Steps 201 and 202 may be simultaneous.

At a step 210 (P SET POINT), control circuit 180 (FIG. 1) receives the values V_{V1} and V_{V2} obtained at steps 201 and 202. Control circuit 180 determines, that is, calculates, from values V_{V1} and/or V_{V2}, a power set point P* (not shown in FIG. 2), representative of a power to be transferred by the converter from H bridge 110 to H bridge 120.

As an example, the converter has an average power set point to be supplied over one or a plurality of alternations of the AC voltage. This average power may correspond to a power to be supplied, for example, to a battery being charged. Set point P* can then be determined based on value V_{V1} alone.

This example is not limiting, and in other examples which may correspond to a different use of a battery charge, set point P* is determined from values V_{V1} and V_{V2}.

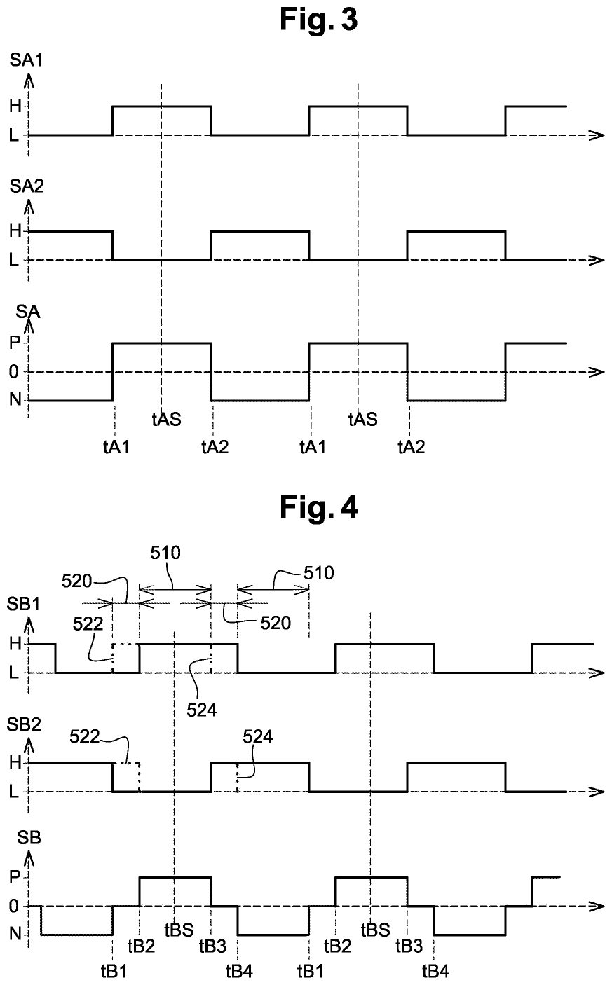

For example, a determination of power set point P* is described in the above-mentioned French patent and US and EP patent applications, in relation with FIG. 3 of these documents. In this example, power set point P* is equal to a target power P1 which is desired to be sampled by the converter from voltage source V1, minus a power P160 representing the power supplied to capacitive element 160 (FIG. 1) during variations of voltage V1. Set point P* then corresponds to the power which is desired to be drawn by the converter from voltage source V1, in order to obtain a PFC-type operation of the converter, which means, for example, an operation where the converter absorbs a sinusoidal current preferentially in phase with the voltage. A PFC-type operation avoids creating a phase shift and/or harmonics in the consumed current with respect to the input voltage.

Powers P1 and P160 are algebraic quantities, which can each take positive and negative values. By algebraic quantity supplied to an element, there is meant that, when the algebraic quantity takes a positive value, the latter is actually supplied to the element, and that, when the algebraic quantity takes a negative value, the latter is, in absolute value, supplied by this element. Set point P* can also take positive and negative values. By negative set point of a power to be transferred from H bridge 110 (FIG. 1) to H bridge 120 (FIG. 1), there is meant that a power represented by the absolute value of this set point is to be transferred from H bridge 120 to H bridge 110. Still in other words, it is desired for energy to flow in both directions between the bridges of the converter.

After steps 201 and 202, at a step 220 (CALC ti), control circuit 280 calculates times ti, repeated at the switching frequency, of the switching operations to be applied to the switches T11H, T11L, T12H, T12L, T21H, T21L, T22H, and T22L of branches 111, 112, 121, and 122.

To calculate switching times ti, a model of the converter is used. The model delivers, as a function of voltages V1 and possibly V2, and of switching times ti, a prediction of the converter operation. The model thus delivers modeled, or predicted, values, that is, values estimated based on the model. These values are, for example, currents, voltages, and/or powers in various elements of the converter, such as the switches or the transformer. The model is preferably such that, in operation, these currents, voltages, and/or powers take values substantially equal to, preferably equal to, the modeled values.

In particular, the model supplies a modeled value P of power transferred by the converter from bridge 110 to bridge 120. The calculations carried out at step 220 are such that times ti are those for which the modeled value allows the transfer of a power equal to set point P*, for example such that the modeled value is equal to the set point value. In other words, the calculation of times ti is based on an equality between:
the power value represented by power set point P*; and
a power calculated based on the model of converter 100 and on values V_{V1} and possibly V_{V2}.

At a step 230 (APPLY SIG), the control signals SIG obtained at step 220 are applied to the switches of the converter. The control signals SIG (FIG. 1) to be applied to the switches of the converter are delivered by control circuit 180 from the calculated times ti.

The method of FIG. 2 is typically implemented repeatedly, measurement steps 201 and 202 being for example continuously carried out, and steps 210 and 220 being for example implemented at each loop of a program of device 180 (FIG. 1).

FIG. 3 shows, schematically and in the form of timing diagrams, an example of a sequence SA of H bridge switching operations used in embodiments of methods of controlling a converter of the type of that in FIG. 1. More particularly, FIG. 3 is a copy of FIG. 4 of the above-mentioned patent and patent applications.

As an example, switching sequence SA is applied to H bridge 110 (FIG. 1). Switching sequence SA is repeated at the switching frequency.

Switching sequence SA comprises two repeated switching cycles SA1 and SA2 in the two respective branches 111 and 112 of H bridge 110. As an example, there have been shown, for each of switching cycles SA1 and SA2, low (L) and high (H) levels corresponding to the on and off states respectively of the switch T11H, T12H of the branch having the switching cycle applied thereto. In other words, the shown states of cycles SA1 and SA2 correspond to the signals for controlling the respective switches T11H and T12H. The signals, not shown, for controlling switches T11L and T12L are, to within dead times, the inverse of the control signals shown for switches T11H and T12H respectively.

In other words, to within dead times, in the example where cycle SA is applied to bridge 110, for each of cycles SA1 and SA2:
the high level corresponds to an on state of the respective switch T11H, T12H and to an off state of the respective switch T11L, T12L; and
the low level corresponds to an off state of the respective switch T11H, T12H, and to an on state of the respective switch T11L, T12L.

Cycles SA1 and SA2 are preferably inverse to each other. In other words, the switches T11H and T12H of bridge 110, located on the side of the same terminal 114H of bridge 110, are controlled in reverse with respect to each other. Similarly, the switches T11L and T12L of bridge 110, located on the side of the same terminal 114L of bridge 110, are controlled in reverse with respect to each other.

Thus, at a time tA1 of each sequence repetition SA, sequence SA comprises two simultaneous switching operations of cycles SA1 and SA2. At time tA1, to within dead times, bridge 110 switches, in other words, toggles, from a state N to a state P. In state N, for two switches (T11H and T12H, or T12L and T11L) of bridge 110 located on the side of a same terminal (114H or 114L respectively) of bridge 110, the off and on states are respectively commanded, and at state P, the on and off states are respectively commanded for these two switches.

Similarly, at a time tA2 of each repetition of sequence SA, bridge 110 switches from state P to state N to within dead times.

At each repetition of the switching sequence, the times tA1 and tA2 of entry and leaving of state P are located symmetrically with respect to a time tAS. Time tAS may as a variant be defined as that with respect to which the times tA2 and tA1 of entry and leaving of state N are symmetrically located.

Each of cycles SA1 and SA2 has a duty cycle defined by the time during which cycle SA1, SA2 is at the level of control of the on state of the respective switch T11H, T12H (high level). In the case of cycles SA1 and SA2 inverse to each other, the duty cycles of cycles SA1 and SA2 have, to within dead times, their sum equal to 1.

Preferably, the duty cycles of cycles SA1 and SA2 are substantially equal to 0.5, more preferably equal to 0.5, to within dead times. In other words, cycles SA1 and SA2, inverse to each other, are also in phase opposition, to within dead times. This results in that sequence SA has identical durations for the two states N and P, to within dead times. At each repetition of sequence SA, these identical durations are located symmetrically with respect to time tA1 or time tA2. Thus, the states N and P of sequence SA are arranged symmetrically with respect to time tAS, to within dead times.

Switching sequence SA, described hereabove in its application to H bridge 110, may be similarly applied to H bridge 120 (FIG. 1), by replacing, with respect to the above-described application to bridge 110, branches 111 and 112 respectively with branches 121 and 122 (FIG. 1). More specifically, for this purpose, as compared with the above-described application to bridge 110, switches T11H, T11L, T12H, and T12L, are respectively replaced with switches T21H, T21L, T22H, and T22L.

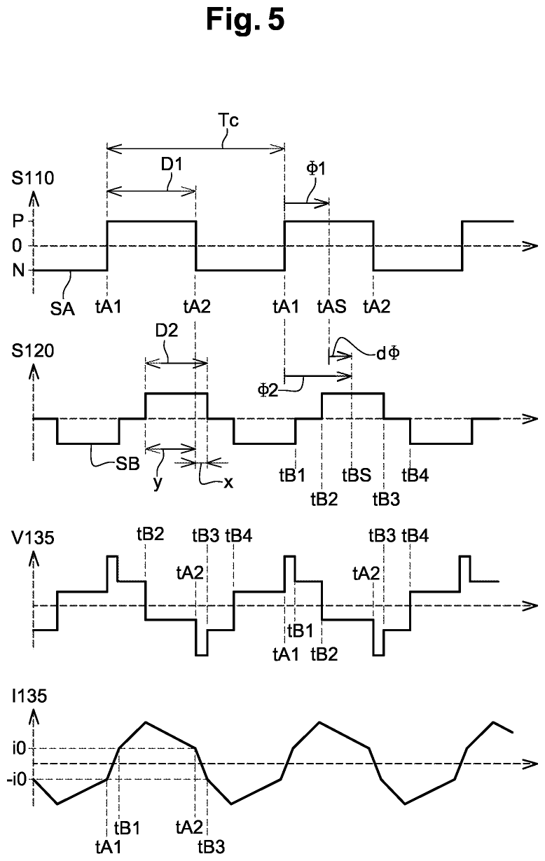

FIG. 4 schematically shows in the form of timing diagrams an example of another sequence of H bridge switching operations used in embodiments of methods of controlling a converter of the type of that of FIG. 1. More particularly, FIG. 4 is a copy of FIG. 5 of the above-mentioned patent and patent applications.

As an example, switching sequence SB is applied to H bridge 120 (FIG. 1). Switching sequence SB is repeated at the same switching frequency as the sequence SA of FIG. 4.

Switching sequence SB comprises two repeated switching cycles SB1 and SB2 in the two respective branches 121 and 122 of H bridge 120. As an example, there have been shown, for each of switching cycles SB1 and SB2, low (L) and high (H) levels corresponding to the on and off states respectively of the switch T21H, T22H of the branch having the switching cycle applied thereto. In other words, the shown states of cycles SB1 and SB2 correspond to the signals for controlling the respective switches T21H and T22H. The signals, not shown, for controlling switches T21L and T22L are, to within dead times, the inverse of the control signals shown for switches T21H and T22H respectively.

In other words, to within dead times, in the example where cycle SB is applied to bridge 120, for each of cycles SB1 and SB2:
the high level corresponds to an on state of the respective switches T21H, T22H and to an off state of the respective switches T21L, T22L; and
the low level corresponds to an off state of the respective switch T21H, T22H, and to an off state of the respective switch T21L, T22L.

Each of cycles SB1 and SB2 has a duty cycle defined by the time during which cycle SB1, SB2 is at the level of control of the on state of the respective switch T21H, T22H (high level). Preferably, the duty cycles of cycles SB1 and SB2 are substantially equal to 0.5, more preferably equal to 0.5, to within dead times.

Cycles SB1 and SB2 are preferably phase-shifted with respect to each other. In other words, cycles SB1 and SB2 have a same duty cycle and have periods 510 during which cycles SB1 and SB2 are at different levels.

This results, at each repetition of sequence SB, in:
a time tB1 of switching of cycle SB2 from its high state to its low state. Bridge 120 switches from a state N to a state O;
a time tB2 of switching of cycle SB1 from its low state to its high state. Bridge 120 switches from state O to state P;
a time tB3 of switching of cycle SB2 from its low state to its high state. Bridge 120 switches from state P to state O; and
a time tB4 of switching of cycle SB1 from its high state to its low state. Bridge 120 switches from state O to state N. sequence SB then returns to its initial state prior to time tB1.
   Times tB1, tB2, tB3, and tB4 follow one another in each sequence, in this order or may be swapped according to the selected initial state of sequence SB.

The states N and P of bridge 120 correspond to the states N and P described in relation with FIG. 3, that is, for the two switches of the bridge located on the side of a same terminal of the bridge, in state N, the off and on states are respectively commanded, and at state P, the on and off states are respectively commanded. State O corresponds to a state in which two switches of bridge 120 located on the side of one of the terminals of bridge 120 are simultaneously in the on state, the other two switches of the bridge (located on the side of the other one of the terminals of bridge 120) then are in the off state. Thus, at state O, the configuration of the switches of bridge 120 corresponds to one among:
the configuration in which switches T21H and T22H are on and switches T21L and T22L are off; and
the configuration in which switches T21H and T22H are off and switches T21L and T22L are on.

At each repetition of the switching sequence, the times tB2 and tB3 of entry and leaving of state P are, to within dead times, located symmetrically with respect to a time tBS. Time tBS may as a variant be defined by that with respect to which the times tB4 and tB1 of entry and of leaving of state are symmetrically located, to within dead times, or by that with respect to which times tB1 and tB2, or tB3 and tB4 are, to within dead times, symmetrically located.

During each of periods 510, sequence SB is in one of states N or P. States N and P are alternated in the successive periods 510. Periods 510 are separated by periods 520 during which the sequence is at state O.

Due to the fact the duty cycles of cycles SB1 and SB2 are equal, periods 520 have identical durations. Further, since the duty cycles of cycles SB1 and SB2 are equal to 0.5, sequence SB is such that periods 510 have identical durations for the two states N and P. As a result, the states N, O, and P of sequence SB are arranged symmetrically with respect to time tBS.

The fact of providing for sequences SA (FIG. 3) and SB (FIG. 4) to have their states, respectively N and P, and N, O, and P, arranged symmetrically with respect to the respective times tAS and tBS enables, in operation, to avoid the presence of a DC component of the current (1135, FIG. 1) in transformer 130 (FIG. 1).

In variants of the embodiments, any other values of duty cycles and/or of phase shifts of the cycles SA1, SA2 and SB1, SB2 of the respective sequences SA and SB may be provided to guarantee the absence of such a DC component. However, the provision of sequences SA and SB symmetrical with respect to times tAS and tBS more simply enables to avoid the DC component. Further, this advantageously results in that that the current in the transformer has, in both its flow directions, variations symmetrical to each other, which simplifies the obtaining of a modeled value of the current in the transformer as a function of time and of a modeled power P such as that defined in relation with FIG. 2.

Although the state O of sequence SB results, in the example of the above-described cycles SB1 and SB2, from the phase shift of cycles SB1 and SB2 with respect to each other, as a variant, it may be provided for the state O of sequence SB to be obtained in a way different from that described hereabove, for example:
by the replacing, at time tB1, of the switching of cycle SB2 from the high state to the low state by a switching of cycle SB1 from the low state to the high state and, at time tB2, of the switching of cycle SB1 from the low state to the high state by a switching of cycle SB2 from the high state to the low state (dotted line 522); and/or
by the replacing, at time tB3, of the switching of cycle SB2 from the low state to the high state by a switching of cycle SB1 from the high state to the low state and, at time tB2, of the switching of cycle SB1 from the high state to the low state by a switching of cycle SB2 from the low state to the low state (dotted line 524).

Switching sequence SB, described hereabove in its application to H bridge 120, may be similarly applied to H bridge 110 (FIG. 1), by replacing, with respect to the above-described application to bridge 120, branches 121 and 122 respectively with branches 111 and 112 (FIG. 1). More specifically, for this purpose, as compared with the above-described application to bridge 120, switches T21H, T21L, T22H, and T22L are respectively replaced with switches T11H, T11L, T12H, and T12L.

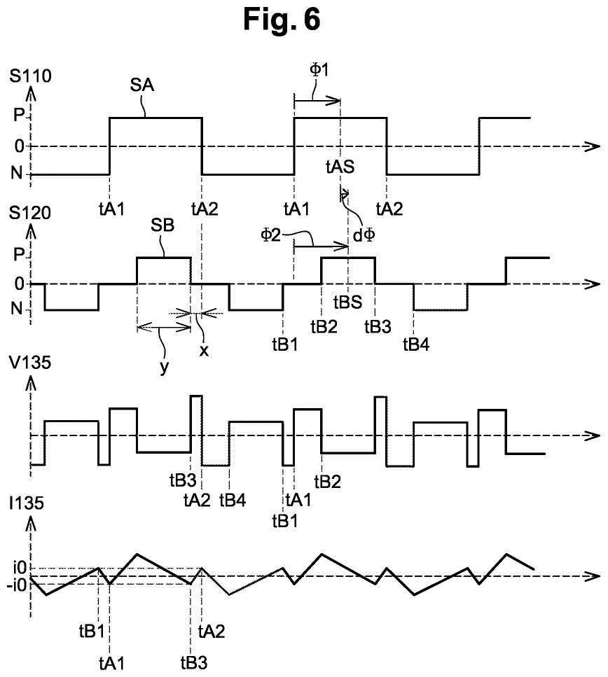

FIGS. 5 and 6 schematically show, in the form of timing diagrams, examples of embodiments of steps of a method of controlling a converter of the type of the converter 100 of FIG. 1. For example, these steps are implemented at step 220 (FIG. 2) of calculation of the bridge switching times t₁ and of generation of the control signals to be applied to the bridges. These examples do not take into account switching dead times.

Each of FIGS. 5 and 6 shows curves as a function of time t normalized by switching period Tc:
of a switching sequence S110 of H bridge 110;
of a switching sequence S120 of H bridge 120;
of the voltage V135 (FIG. 1) across the leakage inductance 135 of transformer 130; and
of a current 1135 flowing through the leakage inductance (that is, in the example shown in FIG. 1, through the winding 131 of the transformer).

At each of the steps shown in FIGS. 5 and 6, the sequences SA and SB shown in FIGS. 3 and 4 are used, and the switching times tA1, tA2, tB1, tB2, tB3, and tB4 of sequences SA and SB are calculated. These times correspond to the times ti described in relation with FIG. 2.

In the examples of FIGS. 5 and 6, voltage V1 is positive, and is applied in a given direction (between nodes 141 and 142, FIG. 1) in a state P of sequence S110, and in the opposite direction (between nodes 142 and 141) in a state N of sequence S110. In other words, the states N and P of sequence S110 correspond to the respective directions in which voltage V1 is applied to the transformer by H bridge 110. A zero voltage is applied between nodes 141 and 142 (in other words, these nodes are short-circuited) in a state O of sequence S110.

Similarly, voltage V2 is positive and applied in a given direction (between nodes 151 and 152, FIG. 1) in a state P of sequence S120, and in an opposite direction (between nodes 142 and 141) in a state N of sequence S120. In other words, the states N and P of sequence S120 correspond to the respective directions in which voltage V2 is applied to the transformer by H bridge 120. A zero voltage is applied between nodes 151 and 152 in a state O of sequence S120.

FIG. 5 illustrates a first converter operating or control mode. In particular, FIG. 5 is a copy of FIG. 6A of the above-mentioned patent and patent applications.

In FIG. 5, it is considered as an example that the voltage V2 across H bridge 120, multiplied by transformation ratio n (that is, a voltage value n*V2) is greater than the peak value of the voltage V1 across H bridge 110. In other words, the value of voltage n*V2 is greater than that of voltage V1. Still in other words, the ratio V1/V2 of the voltages across H bridge 110 and H bridge 120, respectively, is smaller than the transformation ratio n between the winding 132 on the side of H bridge 120 and the winding 131 on the side of H bridge 110. Further, it is provided for energy to flow from H bridge 110 to H bridge 120.

In other words, in the example of FIG. 5, converter 100 (FIG. 1) is considered as operating in boost mode, and the power transferred from bridge 110 to bridge 120 is considered as positive.

In the first operating mode, the sequence SA described hereabove in relation with FIG. 3 is applied to H bridge 110, repeatedly at the switching frequency. Thus, sequence S110 corresponds to sequence SA. In other words, the states P and N of sequence S110 correspond to the respective states P and N of sequence SA, and sequence S110 does not take state O. Further, the sequence SB described hereabove in relation with FIG. 4 is applied to H bridge 120, repeatedly at the switching frequency. Thus, sequence S120 corresponds to sequence SB. In other words, the states P, O, and N of sequence S110 correspond to the respective states P, O, and N of sequence SB.

In the first operating mode, the switching operations to enter and leave a given state of sequence SB from among states N and P occurs in different states of sequence SA. In the present step, the switching operations to enter tB2 and leave tB3 state P of sequence SB respectively occur in states P and N of sequence SA. The switching operations to enter tB4 and leave tB1 the state N of sequence SB occur in states N and P of sequence SA, respectively. In other words, a switching (here at time tA2) of sequence SA takes place between the switching operations to enter and leave (times tB2, tB3) the state P of sequence SB. A switching (here at time tA1) of sequence SA takes place between the switching operations to enter and leave (times tB4, tB1) the state N of sequence SB.

The switching times tB1, tB2, tB3, and tB4 of sequence SB are defined with respect to the times tA1 and tA2 of sequence SA by two parameters x and y. Parameters x and y are in the range from 0 to 0.5 and each correspond to a fraction of switching cycle time Tc (inverse of the switching frequency). Duration y*Tc (represented by letter y) separates each time tB2 from the next time tA2, and duration x*Tc (represented by letter x) separates each time tA2 from the next time tB3. In other words, parameters x and y are values representative of intervals (or durations) between switching times, respectively tA2 and tB3, and tB2 and tA2. Parameters x and y are calculated so that times ti are those for which the modeled value allows the transfer of a power equal to set point P*, for example so that the modeled transmitted power value is equal to the set point value.

Sequences SA and SB are then generated, or applied to bridges 110 and 120, based on the calculated parameters x and y. Sequences SA and SB have between each other a phase shift δϕ, between time tAS and time tBS. The sequences are then applied to H bridges 110 and 120.

Preferably, to generate sequences SA and SB, a reference time of the sequences is defined. This time is for example generated by a clock-type signal at the switching frequency. As an example, the reference time is, in this example, the time tA1 of transition to state P of the sequence S110 applied to H bridge 110. The other switching times of sequences SA and SB are defined by:
a phase shift φ1 of sequence S110 between the reference time tA1 of the sequences and time tAS of symmetry of the sequence SA applied to H bridge 110;
a phase shift φ2 of the sequence S120 between the the reference time tA1 of the sequences and time tBS of symmetry of the sequence SB applied to H bridge 120;
a duty cycle D1 of sequence S110, defined by the ratio of the duration of a state P of sequence S110 to cycle time Tc; and
a duty cycle D2 of sequence S120, defined by the ratio of the duration of a state P of sequence $120 to cycle time Tc.

Phase shifts φ1 and φ2 and duty cycles D1 and D2 are given by the following equalities:

$$D 1 = 0.5 \qquad [ Math 1 ]$$

$$φ 1 = \frac{π}{2}$$

$$D 2 = x + y$$

$$φ 2 = 2. π . ( \frac{1}{2} + \frac{x - y}{2} )$$

Voltage V135 takes values −V1n*V2−, −V1, V1n*V2−, n*V2V1−, V1, and V1+n*V2 when the respective states of sequences S110 and S120 are, respectively, N and P, N and O, P and P, N and N, P and O, and P and N, that is, respectively, between times tA2 and tB3, tB3 and tB4, tB2 and tA2, tB4 and tA1, tB1 and tB2, and tA1 and tB1.

Preferably, to calculate parameters x and y, it is searched for the values of these parameters which enable to obtain an equality between the values i0 of the current 1135 in the transformer at times tB1 and tA2. In other words, parameters x and y, and thus, based on these parameters, times tA1, tA2, tB1, tB2, tB3, and tB4, result from calculations based on a desired, or targeted, equality between the values i0 of the current 1135 in the transformer at the times tB1 of sequence SB and tA2 of sequence SA, times tB1 and tA2 being separated by the time tB2 of sequence SB.

For this purpose, a model of the converter is used, as described in relation with FIG. 2. The model provides modeled values of current 1135 at times tB1 and tA2 as a function of parameters x and y, taking into account values such as those of the voltages V1 and V2 across bridges 110 and 120. The converter model may be any conventional model of a converter comprising two H bridges coupled by a transformer. An example of a model of the converter is described in relation with FIG. 8 of the above-mentioned applications, and corresponds to one or a plurality of algebraic expressions providing the modeled value of current 1135 as a function of time t and of parameters x and y.

Preferably, the calculation of parameters x and y consists in selecting, from among all possible values of parameters x and y, those for which current 1135 has, at times tB1 and tA2, the same modeled values. In other words, the calculated values of parameters x and y are those for which a relation of equality between the values modeled as a function of parameters x and y is fulfilled or verified. This can be achieved by any standard methods of search for parameters for which a relation between values as a function of these parameters is fulfilled.

As indicated and described in the above-mentioned patent and patent applications, the relation between values as a function of parameters x and y may be algebraic, and the selection of values of parameters x and y which verify this relation may be carried out by selecting a single one of the two values (for example, that of parameter x) and by calculating the other of the two values based on this algebraic relation, or may be calculated numerically, the method of search for parameters x and y then typically being a numerical search by successive iterations.

Since current 1135 has symmetrical variations in its two current flow directions, the desired equality between values i0 of current 1135 at times tB1 and tA1 also corresponds to a desired equality between values −i0 of current 1135 at times tA1 and tB3 separated by switching time tB2, as well as to desired equalities, in absolute value, of current 1135 at consecutive times (that is, not separated by a switching) tA1 and tB1, and/or at consecutive times tA2 and tB3.

In variants, the calculation of parameters x and y may be performed based on any desired relation defined as a function of the current in the transformer at the switching times of the two sequences. An example of such a desired relation is a desired equality between a ratio of current values at times tB1 and tA2 to a predefined value which may be different from 1.

Based on the model of the converter, in particular on the modeled values 1135 and V135, there can be calculated a modeled value P of the transferred power as a function of time by the converter from H bridge 110 to H bridge 120, in average at each repetition of the switching sequences.

Preferably, the calculation of parameters x and y then consists in selecting, from among all possible values of parameters x and y, those for which the above-described power set point P* is equal to the modeled value P. In other words, the calculation of parameters x and y is based on an equality between power set point P* and the power calculated based on the model of the converter and on the values of voltages V1 and V2.

In examples of calculation of parameter x and y, the model corresponds to an algebraic expression P (x, y) providing value P as a function of parameters x and y. The calculation may then comprise any usual method, for example numerical, for solving the equation P*=P(x, y) to obtain a set of values to be selected for parameters x and y.

In other examples, the converter model is numerical, and parameters x and y are calculated numerically by any usual method for solving the equation, such as an iterative method.

More preferably, the calculation of parameters x and y, and thus the switching times of sequences SA and SB, is based both on the desired equality between currents at times tB1 and tA2, and on the desired equality between power set point P* and the power transferred by the converter between the bridges.

In variants, the power set point may be replaced with any value representative of a set point supplied to the converter, such as a set point for a current to be drawn from one of the bridges and/or to be supplied by the other one of the bridges. The desired equality between set point P* and the modeled power is then replaced with an equality between this current set point and an average value of this current, modeled according to the converter model, for each repetition of sequences SA and SB.

FIG. 5 has been described for an example where voltages V1 and V2 are positive. However, voltages V1 and V2 may be algebraic quantities. When voltages V1 and/or V2 are negative, the description made hereabove of FIG. 5 applies by replacing the values of voltages V1 and V2 with their absolute values, and, for example, by swapping the states N and P of the respective sequences S110 and/or S120.

FIG. 6 illustrates a second converter operating or control mode. More particularly, FIG. 6 corresponds to the figure referenced as 7A of the above-mentioned patent and patent applications, where references x′ and y′ have been replaced with the respective references x and y.

In the same way as for FIG. 5, FIG. 6 illustrates an example where voltages V1 and V2 have positive values, however, similarly to what has been indicated in relation with FIG. 5, the description made hereafter of FIG. 6 applies for negative values of voltages V1 and/or V2.

In FIG. 6, as in FIG. 5, voltage value n*V2 is higher than voltage value V1, and it is further provided for energy to flow from H bridge 110 to H bridge 120. In other words, in the example of FIG. 6, converter 100 (FIG. 1) is considered as operating in boost mode, and the power transferred from bridge 110 to bridge 120 is considered as positive.

As at the step of FIG. 5, the sequences SA and SB described hereabove in relation with FIGS. 3 and 4 are applied to H bridges 110 and 120, repeatedly at the switching frequency.

However, in the second operating mode, the switching operations to enter and leave a given state of sequence SB from among states N and P take place in a same state of sequence SA. In the present step, the switching operations to enter tB2 and leave tB3 the state P of sequence SB occur at state N of sequence SA. The switching operations to enter tB4 and leave tB1 the state N of sequence SB take place in state P of sequence SA.

The switching times tB1, tB2, tB3, and tB4 of sequence SB are determined with respect to the times tA1 and tA2 of sequence SA by two parameters x and y. Parameters x and y are in the range from 0 to 0.5 and each correspond to a fraction of switching cycle time Tc. Duration y*Tc (represented by y) separates each time tB2 from the next time tB1, and duration x*Tc (represented by x) separates each time tB3 from the next time tA2.

Parameters x and y are, for example, calculated in a way similar to that described in relation with FIG. 5, that is, more preferably:
based on an equality between modeled values, calculated based on the converter model and based on values of the voltages across the bridges, of a current in the transformer at switching times of sequences SA and SB (for example, times tA1 and tB3); and/or
based on an equality between the power represented by set point P* and the corresponding modeled power value P, calculated based on the converter model and based on values of the voltages V1 and V2 across the bridges.

Sequences SA and SB are then generated based on the parameters x and y obtained and applied to H bridges 110 and 120. Sequences SA and SB have between each other phase shift do, described hereabove, between time tAS and time tBS.

Preferably, the switching times of sequences SA and SB are defined with respect to the reference time tA1 by the phase shifts φ1 and φ2 and the duty cycles D1 and D2 defined in relation with FIG. 5.

Phase shifts φ1 and φ2 and duty cycles D1 and D2 are given based on parameters x and y by the following equalities:

$$D 1 = 0.5 \qquad [ Math 2 ]$$

$$φ 1 = π / 2$$

$$D 2 = y$$

$$φ 2 = 2. π . ( \frac{1}{2} - x - \frac{y}{2} )$$

Voltage V135 takes values −V1, V1n*V2−, n*V2V1−, and V1 when the respective states of sequences S110 and S120 are, respectively, N and O, P and P, N and N, P and O, that is, respectively, between times tB3 and tB4, tB2 and tA2, tB4 and tA1, tB1 and tB2. The respective states of sequences S110 and S120 are also, respectively, N and O, P and O between times, respectively tB1 and tA1, tB3 and tA2.

Thus, in the present example of the second operating mode, as compared with the example of the first operating mode of FIG. 5, the respective states N and P, P and N of sequences S110 and S120 between times tA1 and tB1 (FIG. 5) and tA2 and tB3 (FIG. 5), have been replaced with states N and O, P and O. This is due to the fact that the state P of sequence SB begins after time tA1 and ends before time tA2, and the state N of sequence SB begins after time tA2 and ends before time tA1.

In this example, this results in that, between times tA1 and tB1 of FIG. 6, current 1135 varies in the direction opposite to the direction of variation of current 1135 between times tB1 and tA1 of FIG. 5. Similarly, between times tB3 and tA2 of FIG. 6, current 1135 varies in the direction opposite to the direction of variation of current 1135 between times tA2 and tB3 at the step of FIG. 5.

As a result, the power transferred by the converter is relatively low in the second operating mode and relatively high in the first operating mode. Thus, power set point P* determines whether the converter is controlled according to the first or the second operating mode.

As an example, for a given converter model, the power P transferable in the first operating mode, in the case described in relation with FIG. 5, is given by the following equation:

$$P = \frac{V {1}^{2}}{4 . m . fsw . L} ( ( - 4 - 4 . {m}^{2} ) . {x}^{2} + ( 4 . {m}^{2} - 2 . m + 2 ) . x + m - {m}^{2} ) \qquad [ Math 3 ]$$

with fsw the repetition or switching frequency, L a value of the leakage inductance 135 of the converter, and m a ratio of a ratio of the voltages across the two bridges to a transformation ratio of the transformer, in this example equal to V1/(V2.n).

Still as an example, for the same given converter model, the power P transferable in the second operating mode, in the case described in relation with FIG. 6, is given by the following equation:

$$P = \frac{V {1}^{2}}{4. fsw . L} ( 1 - 2 . x ) ( 1 - m . ( 1 - 2 . x ) - 4 . x ) \qquad [ Math 4 ]$$

For the two above equations [Math 3] and [Math 4], the equalities of current values at two times tB1 and tA2 such as described in relation with FIGS. 5 and 6 are respected.

The two above equations [Math 3] and [Math 4] do not take into account possible switching dead times, for example, determined to ensure operations of zero-voltage switching (ZVS) of the switches of the converter.

As an example, an operation where the switching frequency fsw is fixed prior to the calculation of the parameters x and y described hereabove for each of the first and second operating modes is considered. The fixed value of frequency fsw is, for example, called the nominal value of the switching frequency (or repetition frequency of the above-described sequences).

As an example, the nominal value of the switching frequency can be determined as indicated in the above-mentioned patent and patent applications, for example be constant or be calculated based on the values of voltages V1 and V2 and of power set point P*.

As described in relation with FIG. 8 of the above-mentioned patent and patent applications, for this nominal switching frequency value, the value modeled according to a model of the converter of the power P transferred by the converter from H bridge 110 to H bridge 120 can then be determined as a function of parameter x for each of the two operating modes, for example from equations [Math 3] and [Math 4].

According to a power set point P*, it is then determined which of the first and second operating modes is used, and the value of parameter x for this operating mode, based on the equality between set point P* and the modeled transferable power value P.

In such an example, when the converter operates according to the second mode and power set point P* increases beyond a maximum power that the second operating mode enables to transfer, the converter switches from the second mode to the first operating mode. Similarly, when the converter is operating in the first mode and power set point P* decreases below a minimum power that the first operating mode enables to transfer, the converter switches from the first mode to the second operating mode. Switching operations between the first and second operating modes are for example described in the above-mentioned patent and patent applications, in relation with their FIGS. 8, 9, and 10.

In an ideal case with no dead time, at the nominal value of the switching frequency, the switching from the first to the second operating mode, or from the second to the first operating mode, takes place in zero current switching (ZCS), when the parameter x of equations [Math 3] and [Math 4] is equal to 0.

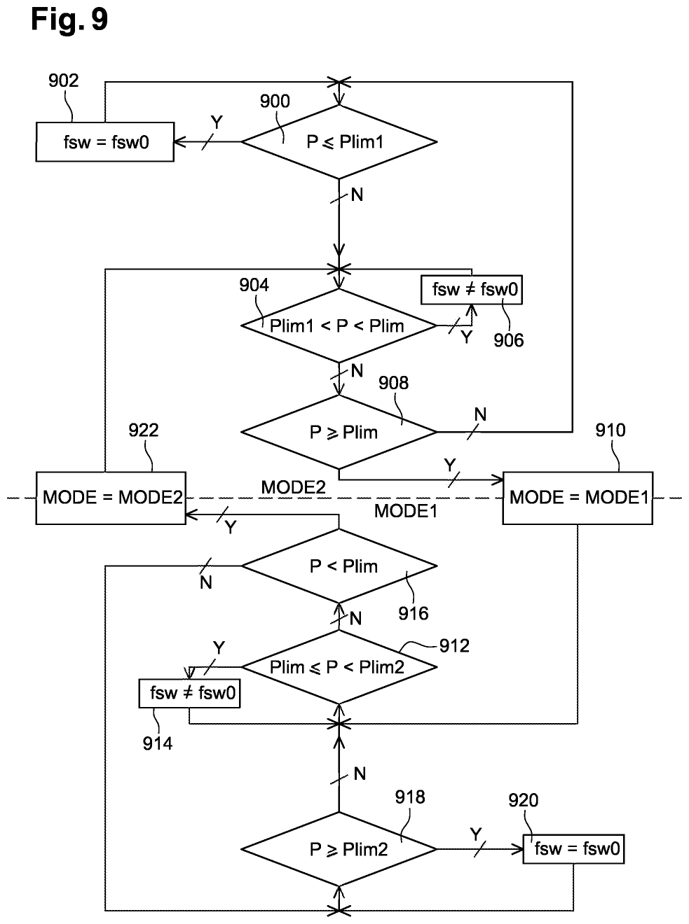

However, in practice, switching dead times are anticipated. The determination of the value or duration of each of the switching dead times is within the abilities of those skilled in the art, for example based on the description of FIG. 9 of the above-mentioned patent and patent applications.

Now, in the converter model determined hereabove by equations [Math 3] and [Math 4], these switching dead times are not taken into account and result in that the zero-voltage switching (ZVS) is lost during a switching between the first and second operating modes for x equal to 0, at the nominal value of the switching frequency.

It is thus provided, in a switched-mode converter of the type of that in FIG. 1, that is, comprising two H bridges coupled by a transformer, and controlled according to the above-described first and second modes, to switch between the first operating mode at the nominal value of the switching frequency and the second operating mode at the nominal value of the switching frequency while taking into account dead times, for example so as to maintain a ZVS operation during the transition from one to the other of these two operating modes, for example by ensuring a ZVS margin.

To achieve this, it is provided for the value of the switching frequency to be adapted during the transition from one to the other of these two operating modes, based on a duration D equal to the duration of the switching dead times or equal to the product of the duration of dead times and a zero-voltage switching margin, or ZVS margin. In other words, the converter is controlled according to one of the two operating modes and at the nominal value of the switching frequency before the switching between the two operating modes, the converter is controlled according to the other of the two operating modes and at the nominal value of the switching frequency after the switching between the two operating modes, and the value of the switching frequency is adapted during the switching between the two operating modes based on the duration of dead times or based on the duration of dead times and on a ZVS margin.

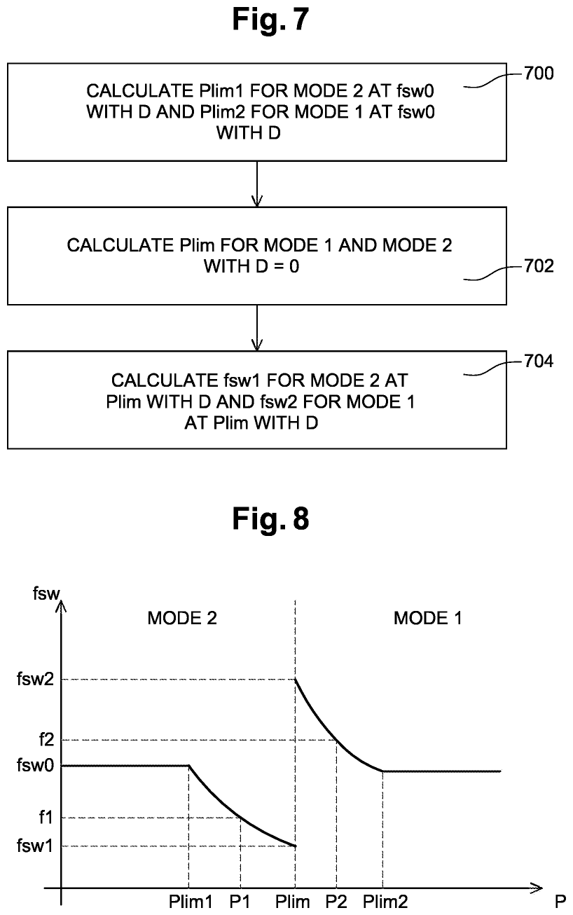

FIG. 7 schematically shows in the form of blocks an embodiment of the adaptation of the value of switching frequency fsw during a transition between the two previously-described operating modes.

At a step 700, (block “CALCULATE Plim1 FOR MODE 2 AT fsw0 WITH D AND Plim2 FOR MODE 1 AT fsw0 WITH D”), the limiting value Plim1 of the modeled power P for which the zero-voltage switching is lost at the nominal value fsw0 of switching frequency fsw is calculated for the second operating mode. Further, the limiting value Plim2 of the modeled power P for which the zero-voltage switching is lost at the nominal value fsw0 of switching frequency fsw is calculated for the first operating mode. At this step, a duration D, for example equal to the duration of dead times, is taken into account. In other words, at this stage, the switching dead times are taken into account.

For a given value of switching frequency fsw and taking into account the duration D of the dead times, the limiting value xlim of the parameter x for which the zero-voltage switching is lost in each of the two operating modes is equal to the product of duration D by switching frequency fsw. In other words:

$$xlim = D . fsw \qquad [ Math 5 ]$$

In other words, this means that the duration xlim/fsw represented by parameter x is then equal to duration D.

Thus, in each of the first and second operating modes, at value fsw0 of frequency fsw, the zero-voltage switching is lost if x is smaller than xlim=D.fsw0.

As an example, when the converter operates as a boost converter and the power transmitted from bridge 110 to bridge 120 is positive, the power Plim1 in the second operating mode is obtained by setting parameter x to value xlim1=D*fsw0 in the model of the second operating mode of the converter, that is, here in equation [Math 4]. In other words:

$$Plim 1 = \frac{V {1}^{2}}{4. fsw 0. L} ( 1 - 2. xlim 1 ) ( 1 - m ( 1 - 2. xlim 1 ) - 4. xlim 1 ) \qquad [ Math 6 ]$$

As an example, when the converter operates as a boost converter and the power transmitted from bridge 110 to bridge 120 is positive, the power Plim2 in the first operating mode is obtained by setting parameter x to value xlim2=D*fsw0 in the model of the first operating mode of the converter, that is, here in equation [Math 3]. In other words:

$$Plim 2 = \frac{V {1}^{2}}{4. m . fsw 0. L} ( ( - 4 - 4. {m}^{2} ) . xlim {2}^{2} + ( 4. {m}^{2} - 2. m + 2 ) . xlim 2 + m - {m}^{2} ) \qquad [ Math 7 ]$$

The value of parameter m, the nominal value fsw0 of switching frequency fsw, duration D, value V1, and the value L of the leakage inductance being known, it is possible to calculate the limiting power values Plim1 and Plim2.

At a step 702 (block “CALCULATE Plim FOR MODE 1 and MODE 2 WITH D=0”), the limiting value Plim of the modeled power P that the converter is capable of delivering for each of the first and second modes at the nominal value fsw0 of the switching frequency and for a zero value of parameter x is calculated. In other words, power Plim is a limiting power transferable at frequency fsw0 in an ideal case with no dead times. As an example, step 702 is implemented after step 700, although it may also be implemented before or simultaneously to step 700.

As an example, when the converter operates as a boost converter and the power transmitted from bridge 110 to bridge 120 is positive, power Plim is obtained by setting parameter x to a zero value in the model of the first or second operating mode of the converter, that is, here, in equation [Math 3] or [Math 4]. In other words:

$$P lim = \frac{V {1}^{2}}{4. m . fsw 0. L} ( m - {m}^{2} ) = \frac{V {1}^{2}}{4. fsw 0. L} ( 1 - m ) \qquad [ Math 8 ]$$

At a step 704 (block “CALCULATE fsw1 for MODE 2 AT Plim WITH D AND fsw2 FOR MODE 1 AT Plim WITH D”), a value fsw1 of switching frequency fsw is calculated. Value fsw1 is the value of frequency fsw enabling, in the second operating mode and when parameter x is equal to xlim, to transfer the power Plim calculated at step 702. Similarly, at this step 704, a value fsw2 of switching frequency fsw is calculated. Value fsw2 is the value of frequency fsw enabling, in the first operating mode and when parameter x is equal to xlim, to transfer the power Plim calculated at step 702.

In an approximate solution, it is considered that at this step 704, value xlim is constant and equal to D times fsw0. The solution is called “approximate solution” because, in practice, for a given frequency fsw, the limiting value xlim for which the zero-voltage switching is lost is equal to D.fsw. Now, during the transition between the two operating modes, the value of frequency fsw varies and does not remain equal to nominal value fsw0, which results in a variation in value xlim. In the approximate solution, it is nevertheless considered that, during the frequency adaptation during the transition between the two operating modes, value xlim is constant and equal to D times fsw0.

As an example, for the approximate solution, when the converter operates as a boost converter and the power transmitted from bridge 110 to bridge 120 is positive, the frequency value fsw1 for the second operating mode is obtained by setting, in the model of the second operating mode of the converter, that is, here, in equation [Math 4], parameter x to value xlim1=D.fsw0 and power P to value Plim. In other words:

$$fsw 1 = \frac{V {1}^{2}}{4. P lim . L} ( 1 - 2. x lim 1 ) ( 1 - m ( 1 - 2. x lim 1 ) - 4. x lim 1 ) \qquad [ Math 9 ]$$

As an example, for the approximate solution, when the converter operates as a boost converter and the power transmitted from bridge 110 to bridge 120 is positive, the frequency value fsw2 for the first operating mode is obtained by setting, in the model of the first operating mode of the converter, that is, here, in equation [Math 3], parameter x to value xlim2=D.fsw0 and power P to value Plim. In other words:

$$fsw 2 = \qquad [ Math 10 ]$$

$$\frac{V {1}^{2}}{4. m . P lim . L} ( ( - 4 - 4. {m}^{2} ) . x lim {2}^{2} + ( 4. {m}^{2} - 2. m + 2 ) . x lim 2 + m - {m}^{2} )$$

In an exact solution, between powers Plim1 and Plim2, that is, during the transition between the two operating modes during which the frequency is adapted, it is considered that value xlim is not constant and equal to D times fsw0, but on the contrary that it varies with frequency according to relation xlim=D.fsw.

Thus, in the exact solution, calculating the frequency fsw1 for which the second operating mode enables Plim to be transferred with x equal to xlim1, that is, to D times fsw1, comes down to calculating, with the model of transferable power P of the second operating mode, which is the value xlim1 of parameter x enabling to transfer the power Plim calculated at step 702, and then to deducing therefrom the value fsw1 of frequency fsw based on relation fsw1=xlim1/D. Similarly, in the exact solution, calculating the frequency fsw2 for which the first operating mode enables to transfer Plim with x equal to xlim2, that is, D times fsw2, comes down to calculating, with the model of transferable power P of the first operating mode, which value xlim2 of parameter x enables to transfer the power Plim calculated at step 702, and then to deducing therefrom the value fsw2 of switching frequency fsw based on relation fsw2=xlim2/D.

As an example, for the exact solution, when the converter is operating as a boost converter and the power transmitted from bridge 110 to bridge 120 is positive, the value xlim1 enabling to transfer power Plim in the second mode without losing the zero-voltage switching is obtained by solving a second-degree equation having xlim1=fsw1.D as an unknown. This second-degree equation is obtained based on the converter model for the second operating mode, that is, equation [Math 4], by setting in this model power P to value Plim and by replacing fsw with fsw1, that is, with xlim1/D. This comes down to solving the following second-degree equation:

$$0 = ( - 4. m + 8 ) . x lim {1}^{2} + ( 4. m - 6 - \frac{4. P lim . L}{D . V {1}^{2}} ) . x lim 1 + ( 1 - m ) \qquad [ Math 11 ]$$

Assuming that:
alim1=(−4.m+8),
blim1=(4.m−6−(4.Plim.L)/(D.V12), and
clim1=(1−m), one obtains:

$$x lim 1 = \frac{- b lim 1 - \sqrt{4. a lim 1. c lim 1}}{2. a lim 1} \qquad [ Math 12 ]$$

One then has fsw1=xlim1/D.

Still as an example, for the exact solution, when the converter operates as a boost converter and the power transmitted from bridge 110 to bridge 120 is positive, the value xlim2 enabling to transfer power Plim in the first operating mode without losing the zero-voltage switching is obtained by solving a second-degree equation having xlim2 as an unknown. This second-degree equation is obtained based on the converter model for the first operating mode, that is, equation [Math 3], by setting power P in this model to value Plim and by replacing fsw with fsw2, that is, with xlim2/D. Thus, this comes down to solving the following second-degree equation:

$$0 = ( - 4. {m}^{2} - 4 ) . x lim {2}^{2} + ( 4. {m}^{2} - 2. m - \frac{4. m . P lim . L}{D . V {1}^{2}} ) . x lim 2 + ( m - {m}^{2} ) \qquad [ Math 13 ]$$

Assuming that:
alim2=(−4.m²−4),
blim2=(4.m²−2.m−(4.m.Plim.L)/(D.V12)), and
clim2=(m-m²), one obtains:

$$x lim 2 = \frac{- b lim 2 - \sqrt{4. a lim 2. c lim 2}}{2. a lim 2} \qquad [ Math 14 ]$$

One thus obtains fsw2=xlim2/D.

As an example, steps 700, 702, and 704 are implemented at step 220 of FIG. 2.

As an example, steps 700, 702, and 704 are implemented by a processing circuit of the converter, for example by the processing circuit 180 (FIG. 1) of converter 100, for example by the processing unit of this circuit 180, for example adapting the program stored in the memory of circuit 180.

FIG. 8 shows, schematically and by means of curves, an embodiment of still another step of control of the converter of FIG. 1. More particularly, FIG. 8 illustrates the variation of frequency fsw as a function of the power P transferable during a transition between the first operating mode (MODE 1 in FIG. 8) at the nominal value fsw0 of frequency fsw and the second operating mode (MODE 2 in FIG. 8) at the nominal value fsw0 of frequency fsw. In other words, FIG. 8 illustrates a step of control of the converter according to an embodiment where frequency fsw is adapted during a transition between the two operating modes, based on duration D.

As can be seen in FIG. 8, at the nominal value fsw0 of frequency fsw, when the transferable power P is lower than the power Plim1 calculated at step 700 (FIG. 7), the converter is controlled according to the second operating mode, MODE 2. In this first region, the value of parameter x and the corresponding times ti are for example calculated at step 220 (FIG. 2), after which the corresponding control signals are for example applied to the switches of the bridge at step 230 (FIG. 2).

In this first operating region, parameter x is calculated as previously indicated in relation with step 220 (FIG. 2), based on an equality between power set point P* and the modeled transferable power P, the latter being for example determined by equation [Math 4] in a given model of the converter.

For example, at each variation of power set point P*, as long as set point P* remains lower than value Plim1, parameter x is recalculated to respect the equality P*=P, and the switching times ti are deduced or calculated from the recalculated value of parameter x.

When, in the second mode MODE 2, frequency fsw is at its nominal value and set point P*, that is, power P, reaches limiting value Plim1, parameter x is then equal to xlim1=D.fsw0. Based on power Plim1, the value of frequency fsw is adapted and is no longer kept constant and equal to fsw0.

More specifically, in mode MODE 2, in a second operating region where power P is in the range from Plim1 to Plim, the value of frequency fsw is in the range from fsw0 to fsw1. For example, in this second region, the value of frequency fsw decreases as power P increases.

In this second region, the value of parameter x, the value of frequency fsw, and the corresponding times ti are, for example, calculated at step 220 (FIG. 2), after which the corresponding control signals are, for example, applied to the switches of the bridges at step 230 (FIG. 2) at frequency fsw. In particular, in this second region, the value of parameter x is equal to D.fsw0 (approximate solution) or to D.fsw (exact solution).

For example, in mode MODE 2, for a set point P* (that is, a modeled power P) equal to a value P1 in the range from Plim1 to Plim, the corresponding value f1 of frequency fsw is calculated by using the model of the second mode, and by setting parameter x to value x1 equal to fsw0.D (approximate solution) or to f1.D (exact solution).

As an example, for the approximate solution, when the converter operates as a boost converter and the power transmitted from bridge 110 to bridge 120 is positive, the value f1 of frequency fsw for the second operating mode is obtained by setting, in the model of the second operating mode of the converter, that is, here, in equation [Math 4], parameter x to value x1=D.fsw0=xlim1 and power P to value P1. In other words, this comes down to solving the following equation:

$$f 1 = \frac{V {1}^{2}}{4. P 1. L} ( 1 - 2. x 1 ) ( 1 - m ( 1 - 2. x 1 ) - 4. x 1 ) \qquad [ Math 15 ]$$

As an example, for the exact solution, when the converter operates as a boost converter and the power transmitted from bridge 110 to bridge 120 is positive, the value x1 enabling to transfer power P1 in the second mode and without losing the zero-voltage switching is obtained by solving a second-degree equation having x1 as an unknown. This second-degree equation is obtained based on the converter model for the second operating mode, that is, equation [Math 4], by setting in this model power P to value P1 and by replacing fsw with f1, that is, with x1/D. This comes down to solving the following second-degree equation:

$$0 = ( - 4. m + 8 ) . x {1}^{2} + ( 4. m - 6 - \frac{4. P lim . L}{D . V {1}^{2}} ) . x 1 + ( 1 - m ) \qquad [ Math 16 ]$$

Assuming that:
a1=(−4.m+8),
b1=(4.m−6−(4.P1.L)/(D.V12), and
c1=(1-m), one obtains:

$$x 1 = \frac{- b 1 - \sqrt{4. a 1. c 1}}{2. a 1} \qquad [ Math 17 ]$$

One thus obtains f1=x1/D.

When, in second mode MODE 2, set point P*, and thus power P, reaches limiting value Plim, parameter x is equal to D.fsw0 (approximate solution) or to D*fsw1 (exact solution), and frequency fsw is equal to fsw1.

At this point, the converter control or operating mode switches from the second mode, MODE 2, to the first mode, MODE 1. To achieve this, frequency value fsw switches from fsw1 to fsw2. In other words, the switching from MODE 2 to MODE 1 comprises a jump of frequency fsw from its value fsw1 to its value fsw2. In practice, value fsw2 is higher than value fsw1.

In mode MODE 1, in a third operating region where power P is in the range from Plim to Plim2, the value of frequency fsw is in the range from fsw2 to fsw0. For example, in this third region, the value of frequency fsw decreases as power P increases.

In this third region, the value of parameter x, the value of frequency fsw, and the corresponding times ti are, for example, calculated at step 220 (FIG. 2), after which the corresponding control signals are, for example, applied to the switches of the bridges at step 230 (FIG. 2) at frequency fsw. In particular, in this third region, the value of parameter x is equal to D.fsw0 (approximate solution) or to D.fsw (exact solution).

For example, in mode MODE 1, for a set point P* (that is, a modeled power P) equal to a value P2 in the range from Plim to Plim2, the corresponding value f2 of frequency fsw is calculated by using the model of the first mode, and by setting parameter x to value x2 equal to fsw0.D (approximate solution) or to f2.D (exact solution).

As an example, for the approximate solution, when the converter operates as a boost converter and the power transmitted from bridge 110 to bridge 120 is positive, the value f2 of frequency fsw for the first operating mode is obtained by setting, in the model of the first operating mode of the converter, that is, here in equation [Math 3], parameter x to value x2=D.fsw0=xlim2 and power P to value P2. In other words, this comes down to solving the following equation:

$$f 2 = \frac{V {1}^{2}}{4. m . P 2. L} ( ( - 4 - 4. {m}^{2} ) . x {2}^{2} + ( 4. {m}^{2} - 2. m + 2 ) . x 2 + m - {m}^{2} ) \qquad [ Math 18 ]$$

As an example, for the exact solution, when the converter operates as a boost converter and the power transmitted from bridge 110 to bridge 120 is positive, the value x2 enabling to transfer power P2 in the first mode and without losing the zero-voltage switching is obtained by solving a second-degree equation having x2 as an unknown. This second-degree equation is obtained based on the converter model for the second operating mode, that is, equation [Math 4], by setting in this model power P to value P2 and by replacing fsw with f2, that is, with x2/D. This comes down to solving the following second-degree equation:

$$0 = \qquad [ Math 19 ]$$

$$( - 4. {m}^{2} - 4 ) . x {2}^{2} + ( 4. {m}^{2} - 2. m + 2 - \frac{4. m . P 2. L}{D . V {1}^{2}} ) . x 2 + ( m - {m}^{2} )$$

Assuming that:
a2=(−4.m²−4),
b2=(4.m²−2.m+2−(4.m.P2.L)/(D.V12), and
c2=(m-m²), one obtains:

$$x 2 = \frac{- b 2 - \sqrt{4. a 2. c 2}}{2. a 2} \qquad [ Math 20 ]$$

One then obtains f2=x2/D.

When, in mode MODE 1, set point P*, and thus power P, reaches limiting value Plim2, parameter x is then equal to xlim2=D.fsw0, and frequency fsw is at its value fsw0. In a fourth operating region where power P is higher than Plim2, the value of frequency fsw is no longer adapted and is kept constant and equal to fsw0.

A transition from mode MODE 2 to mode MODE 1 has been described hereabove in relation with FIG. 8. In particular, during this transition, the switching from mode MODE 2 to mode MODE 1 when power P is equal to Plim comprises a jump of frequency fsw from value fsw1 to value fsw2. Those skilled in the art will be capable of deducing from this description, by symmetry of operation, the description of a transition from mode MODE 1 to mode MODE 2, for example as a result of a decrease of power set point P*. In particular, during a transition from mode MODE 1 to mode MODE 2, the switching from mode MODE 1 to mode MODE 2 when power P is equal to Plim comprises a jump of frequency fsw from value fsw2 to value fsw1.

FIG. 9 shows, schematically and in the form of blocks, an embodiment of the control step of FIG. 8.

At a step 900 (block “P≤Plim1”), it is verified whether power set point P* (and thus power P) is lower than value Plim1.

If this is the case (output Y of block 900), the converter is in the first operating region and the converter is controlled according to mode MODE 2. Further, the method continues at a step 902 (block “fsw=fsw0”) where frequency fsw is set to its nominal value fsw0, after which the method loops back onto step 900. In the first region, parameter x and times ti are, for example, calculated as indicated in relation with FIG. 8.

If this is not the case (output N of block 900), the method continues at a subsequent step 904 (block “Plim1<P<Plim”).

At step 904, it is verified whether power set point P* (and thus power P) is in the range from Plim1 to Plim.

If this is the case (output Y of block 904), this means that the converter is in the previously-described second operating region and is thus controlled according to mode MODE 2. The method then continues at a step 906 (block “fsw/fsw0”) where frequency fsw is no longer kept constant and equal to its nominal value fsw0, but is adapted based on duration D, that is, taking into account the duration of dead times. In this second region, parameter x and times ti are, for example, calculated as indicated in relation with FIG. 8. Step 906 is followed by step 904.

If this is not the case (output N of block 904), the method continues at a step 908 (block “P≥Plim”).

At step 908, it is verified whether power set point P* (and thus power P) is greater than or equal to Plim.

If this is not the case (output N of block 908), due to the fact that step 908 follows step 904, this means that power P is neither in the range from Plim1 to Plim, nor greater than Plim, and thus power P is lower than Plim1 and the converter is in the first operating region. The method then continues at step 900 as shown in FIG. 9, or, as a variant, at step 902.

If this is the case (output Y of block 908), the process continues at a step 910 (block “MODE=MODE 1”) where the converter switches from operating mode MODE 2 to operating mode MODE 1, as illustrated by dotted lines in FIG. 9. Step 910 is followed by step 912 (block “Plim≤P<Plim2”) as shown in FIG. 9 or, as a variant, by step 918 (block “P≥Plim2”).

At step 912, it is verified whether power set point P* (and thus the power P) is in the range from Plim to Plim2.

If this is the case (output Y of block 912), this means that the converter is in the previously-described third operating region and is thus controlled according to mode MODE 1. The method then continues at a step 9914 (block “fsw/fsw0”) where frequency fsw is no longer kept constant and equal to its nominal value fsw0, but is adapted based on duration D, that is, taking into account the duration of dead times. In this third region, parameter x and times ti are, for example, calculated as described in relation with FIG. 8. Step 914 is followed by step 912.

If this is not the case (output N of block 912), the method continues at step 916 (block “P<Plim”).

At step 916, it is verified whether power set point P* (and thus power P) is lower than Plim.

If this is not the case (output N of block 916), due to the fact that step 916 follows step 912, this means that power P is neither in the range from Plim to Plim2, nor lower than Plim, and thus that power P is higher than Plim2 and the converter is in the fourth operating region. The method then continues at step 918 as shown in FIG. 9, or as a variant at step 920 (block “fsw=fsw0”).

If this is the case (output Y of block 916), the method continues at step 922 (block “MODE=MODE 2”), during which the converter switches from operating mode MODE 1 to operating mode MODE 2, as illustrated by the dotted lines in FIG. 9. Step 922 is followed by step 904 as shown in FIG. 9, or as a variant, by step 900.

At step 918, it is verified whether power set point P* (and thus power P) is greater than or equal to value Plim2.

If this is the case (output Y of block 918), the converter is in the fourth operating region and the converter is controlled according to mode MODE 1. Further, the method continues at step 920, where frequency fsw is set to its nominal value fsw0, after which the method loops back onto step 920. In the fourth region, parameter x and times ti are, for example, calculated as shown in relation with FIG. 8.

If this is not the case (output N of block 918), the method continues at step 912.

In the above example, it has been assumed that when power P is equal to Plim, the converter is controlled according to mode MODE 1. Those skilled in the art will be capable of adapting the above method to examples where, when power P is equal to Plim, the converter is controlled according to mode MODE 2. More generally, those skilled in the art will be capable of modifying the above example by replacing strict inequalities with inequalities including the case of equality, and vice versa.

There has been previously described, in relation with FIGS. 7 to 9, an approximate solution in which, to calculate Plim, the frequency fsw when power P is in the range from Plim1 to Plim, and the frequency fsw when power P is in the range from Plim to Plim2, parameter x is considered as constant and equal to D.fsw0. When duration D is equal to the duration of dead times and power P is in the range from Plim1 to Plim, this amounts to overestimating value xlim=D.fsw due to the fact that frequency fsw is then in the range from fsw0 to fsw1, and thus lower than fsw0. However, when duration D is equal to the duration of dead times and power P is in the range from Plim to Plim2, this comes down to underestimating value xlim=D.fsw due to the fact that frequency fsw is in the range from fsw2 to fsw0, and thus greater than fsw0.

Thus, at least with the approximate solution, instead of using a duration D equal to the duration of dead times, it is preferable to use a duration D equal to the product of the duration of dead times by a margin ZVS, noted A and greater than 1, for example in the range from 1.1 to 1.5, for example equal to 1.1. This is more particularly true for the calculation of power Plim2, of frequency fsw2, and for the calculation of the value of frequency fsw when power P is in the range from Plim to Plim2.

In the description made hereabove in relation with FIGS. 5 to 9, the converter operates in boost mode, that is, voltage V1 is lower than a voltage n. V2 (m<1), and the power transferred from bridge 110 to bridge 120 is positive. Those skilled in the art will be capable of adapting the description made in relation with FIGS. 5 to 9 to cases where the converter operates in buck mode, that is, voltage V1 is greater than voltage n. V2 (m>1), and the power transferred from bridge 110 to bridge 120 is positive. For this purpose, those skilled in the art may, for example, refer to the above-mentioned FR patent and EP and US patent applications or, as an alternative example, make the following changes of variables in the previously-described calculations: the voltage V1 described in relation with a boost operation is replaced with a voltage n. V2 in a buck operation, with V2 the voltage across bridge 120 in buck mode, and the voltage V2 described in relation with a boost operation is replaced with a voltage V1/n in a buck operation, with V1 the voltage across bridge 110 in buck mode.

Further, whether the converter operates in buck or boost mode, it has been assumed up to now that the power transferred from bridge 110 to bridge 120 is positive. However, those skilled in the art are capable of adapting the above description to the case where the power transferred from bridge 110 to bridge 120 is negative, either due to the fact that calculations with a negative power are similar, or considering that the transferred power is always positive until the calculation of the phase shift, or phase difference, δϕ between sequences SA and SB, and by selecting the sign of the transferred power at the time of the calculation of this phase shift.

A specific example of a converter model has been described hereabove, this model being determined by equations [Math 3] for mode MODE 1 and [Math 4] for mode MODE 2. Those skilled in the art are capable, based on this example, of adapting the above-described calculation steps to other models of the converter, for example by taking the resistances into account, which would lead to a model determined by equations different from equations [Math 3] and [Math 4].

Various embodiments and variants have been described. Those skilled in the art will understand that certain features of these various embodiments and variants may be combined, and other variants will occur to those skilled in the art.

Finally, the practical implementation of the described embodiments and variants is within the abilities of those skilled in the art based on the functional indications given hereabove.

1. Method of controlling a converter comprising two H bridges coupled by a transformer, wherein:
repetitions, at a repetition frequency, of two sequences of switching operations between a plurality of states are respectively applied to the two bridges;
one of the states of a first one of the two sequences corresponds to a given direction of application of a voltage to the transformer by the bridge having the first one of the two sequences applied thereto;
in a first control mode, switching operations to enter and leave said one of the states of the first one of the two sequences occur in different states of the second one of the two sequences;
in a second control mode, switching operations to enter and leave said one of the states of the first one of the two sequences occur in a same state of a second one of the two sequences; and
each transition between the first mode at a nominal value of the repetition frequency and the second mode at the nominal value of the repetition frequency comprises an adaptation of the repetition frequency determined by a first duration equal to a switching dead time duration or to the product of the switching dead time duration and of a zero-voltage switching margin.

2. The method according to claim 1, wherein each transition comprises, based on a model of the converter:
the calculation of a first power transferable between the two bridges with the first mode and the nominal value of the repetition frequency, the first power being determined by the first duration;
the calculation of a second power transferable between the two bridges with the second mode and the nominal value of the repetition frequency, the second power being determined by the first duration;
the calculation of a third power transferable between the two bridges in the first and second modes at the nominal value of the repetition frequency and without taking into account the first duration;
the calculation of a first value of the repetition frequency in the first mode, the first value of the repetition frequency being determined by the third transferable power and the first duration; and
the calculation of a second value of the repetition frequency in the second mode, the second value of the repetition frequency being determined by the third transferable power and the first duration.

3. The method according to claim 2, wherein:
each transition from the first mode to the second mode comprises a jump from the first value to the second value of the repetition frequency; and
each transition from the second mode to the first mode comprises a jump from the second value to the first value of the repetition frequency.

4. The method according to claim 2, wherein:
each transition from the first mode with the nominal value of the repetition frequency to the second mode with the nominal value of the repetition frequency successively comprises:
in the first mode, transiting from the first power to the third power by transiting from the nominal value of the repetition frequency to the first value of the repetition frequency,
at the third power, switching from the first mode to the second mode by switching from the first value of the repetition frequency to the second value of the repetition frequency, and
in the second mode, transiting from the third power to the second power by transiting from the second value of the repetition frequency to the nominal value of the repetition frequency; and
each transition from the second mode with the nominal value of the repetition frequency to the first mode with the nominal value of the repetition frequency successively comprises:
in the second mode, transiting from the second power to the third power by transiting from the nominal value of the repetition frequency to the second value of the repetition frequency,
at the third power, switching from the second mode to the first mode by switching from the second value of the repetition frequency to the first value of the repetition frequency, and
in the first mode, transiting from the third power to the first power by transiting from the first value of the repetition frequency to the nominal value of the repetition frequency.

5. The method according to claim 2, wherein:
the two sequences each comprise two respective switching cycles of two branches of the bridge having the sequence applied thereto; and
the switching operations of the sequences occur at times resulting from calculations based on an equality between:
a set point power to be transferred between the bridges by the converter; and
a transferable power calculated based on the converter model and based on values of the voltages across the bridges.

6. The method according to claim 5, wherein the set point is calculated as a function of a voltage value received by one of the bridges and/or of a voltage value to be delivered by the other of the bridges.

7. The method according to claim 6, wherein the set point is calculated so that the converter has a PFC-type operation.

8. The method according to claim 5, wherein said calculations are further based on a desired equality between values of a current in the transformer at one of the switching times of one of the two sequences and at one of the switching times of the other one of the two sequences.

9. The method according to claim 5, wherein:
the model comprises a first parameter representative of a second duration between switching times of the two sequences in the first mode and of a third duration between switching times of the two sequences in the second mode;
the first transferable power in the first mode is calculated based on the model by using a first value of the first parameter corresponding to an equality of the first and second durations;
the third transferable power in the first and second modes is calculated based on the model by using a zero value of the first parameter; and
the second transferable power in the second mode is calculated based on the model by using the first value of the first parameter corresponding to an equality of the first and third durations.

10. The method according to claim 9, wherein:
in the first mode, the model is determined by the following equation:
$$P = \frac{V {1}^{2}}{4. m . fsw . L} ( ( - 4 - 4. {m}^{2} ) . {x}^{2} + ( 4. {m}^{2} - 2. m + 2 ) . x + m - {m}^{2} ) \qquad [ Math 21 ]$$
where P is the transferable power, V1 is a voltage across one of the two bridges, x is the first parameter, fsw is the repetition frequency, L is a value of a leakage inductance of the converter, and m is a ratio of a ratio of the voltages across the two bridges to a transformation ratio of the transformer; and
in the second mode, the model is determined by the following equation:
$$P = \frac{V {1}^{2}}{4. fsw . L} ( 1 - 2. x ) ( 1 - m . ( 1 - 2. x ) - 4. x ) . \qquad [ Math 22 ]$$

11. Device configured to implement the method according to claim 1.

12. Converter comprising a device according to claim 11.
